(19) United States
(12) Patent Application Publication
(10) Pub. No.: US 2015/0145689 A1
(43) Pub. Date: May 28, 2015

(54) ADVANCED METERING INFRASTRUCTURE SITE SURVEY SYSTEM

(71) Applicant: Institute For Information Industry, Taipei (TW)

(72) Inventors: Chih-Chiang HSIEH, Taipei City (TW); Ping-Heng LI, Taipei City (TW); Tung-Yuan LEE, Luzhu Township (TW)

(73) Assignee: Institute For Information Industry, Taipei (TW)

(21) Appl. No.: 14/101,264

(22) Filed: Dec. 9, 2013

(30) Foreign Application Priority Data
Nov. 25, 2013 (TW) 102142779

(51) Int. Cl. G01D 4/00

(52) U.S. Cl. CPC G01D 4/002
USPC 340/870.02

(57) ABSTRACT

An advanced metering infrastructure (AMI) site survey system is provided. The AMI site survey system includes a gateway simulation equipment and a smart meter simulation equipment. The gateway simulation equipment communicates with a server via a WAN communication protocol, and communicates with the smart meter simulation equipment via a LAN communication protocol. The smart meter simulation equipment sends a piece of power simulation information, and transmits the power simulation information to the gateway simulation equipment based on the LAN communication protocol. The gateway simulation equipment transmits the power simulation information to the server based on the WAN communication protocol so that the server records a network transmission status of the transmission of the power simulation information via the WAN communication protocol and the LAN communication protocol.

### PRIORITY

This application claims priority to Taiwan Patent Application No. 102142779 filed on Nov. 25, 2013, which is hereby incorporated by reference in its entirety.

### FIELD

The present invention relates to an advanced metering infrastructure (AMI) site survey system; more specifically, the AMI site survey system of the present invention can evaluate the overall communication of a smart meter, a gateway and a server.

### BACKGROUND

Use of the AMI can improve the power efficiency substantially and further save energy, so replacing the existing common meter infrastructure with the AMI will become a trend in the future. However, replacing the common meter infrastructures of all electricity consumers with the AMIs is a time-consuming project. In order to avoid the unnecessary cost incurred by re-replacement of the AMI, a site survey is usually made before the practical replacement.

Specifically, the AMI is usually comprised of a smart meter, a gateway and a server. The smart meter communicates with the gateway through a local area network (LAN), and the gateway communicates with the server through a wide area network (WAN). Because environments of the clients at which the smart meters need to be installed are not all the same, site surveys on various communication protocols need to be made before practical installation to determine which communication protocol is more suitable to the environment of the client.

However, the conventional site survey technology is inconvenient due to the reasons as follows: (1) different testing tools are required for different communication protocols when signal evaluation is made on the LAN between the smart meter and the gateway; (2) different testing tools must be manually replaced on site to test different communication protocols, which increases the labor cost and consumes the limited testing time; (3) the LAN evaluation between the smart meter and the gateway is performed separately from the WAN evaluation between the gateway and the server, so the value for reference of the overall transmission efficiency of information transmission from the smart meter to the server is lowered substantially.

Accordingly, an urgent need exists in the art to develop new hardware equipment capable of evaluating the overall network transmission of the smart meter, the gateway and the server in a more automatic way.

### SUMMARY

A primary objective of certain embodiments of the present invention is to provide an advanced metering infrastructure (AMI) site survey system, which comprises a gateway simulation equipment and a smart meter simulation equipment. The gateway simulation equipment includes a gateway processing module, a wide area network (WAN) transmission module and a first gateway local area network (LAN) transmission module. The smart meter simulation equipment includes a information simulation processing module and a first smart meter LAN transmission module.

The WAN transmission module of the gateway simulation equipment communicates with a server via a WAN communication protocol. The first smart meter LAN transmission module communicates with the first gateway LAN transmission module via a first LAN communication protocol. The information simulation processing module is configured to send a piece of power simulation information and control the first smart meter LAN transmission module to transmit the power simulation information to the first gateway LAN transmission module based on the first LAN communication protocol.

The gateway processing module is configured to control the WAN transmission module to transmit the power simulation information to the server based on the WAN communication protocol so that the server records a network transmission status of the transmission of the power simulation information via the first LAN communication protocol and the WAN communication protocol.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an AMI site survey system according to a first embodiment of the present invention;

FIG. 1B is a block diagram of a gateway simulation equipment according to the first embodiment of the present invention;

FIG. 1C is a block diagram of a smart meter simulation equipment according to the first embodiment of the present invention;

FIG. 2A is a schematic view of an AMI site survey system according to a second embodiment of the present invention;

FIG. 2B is a block diagram of a gateway simulation equipment according to the second embodiment of the present invention; and

FIG. 2C is a block diagram of a smart meter simulation equipment according to the second embodiment of the present invention.

### DETAILED DESCRIPTION

In the following description, the present invention will be explained with reference to example embodiments thereof. However, these example embodiments are not intended to limit the present invention to any specific examples, embodiments, environment, applications or implementations described in these embodiments. Therefore, description of these example embodiments is only for purpose of illustration rather than to limit the present invention. In the following embodiments and the attached drawings, elements unrelated to the present invention are omitted from depiction; and dimensional relationships among individual elements in the following attached drawings are illustrated only for ease of understanding, but not to limit the actual scale.

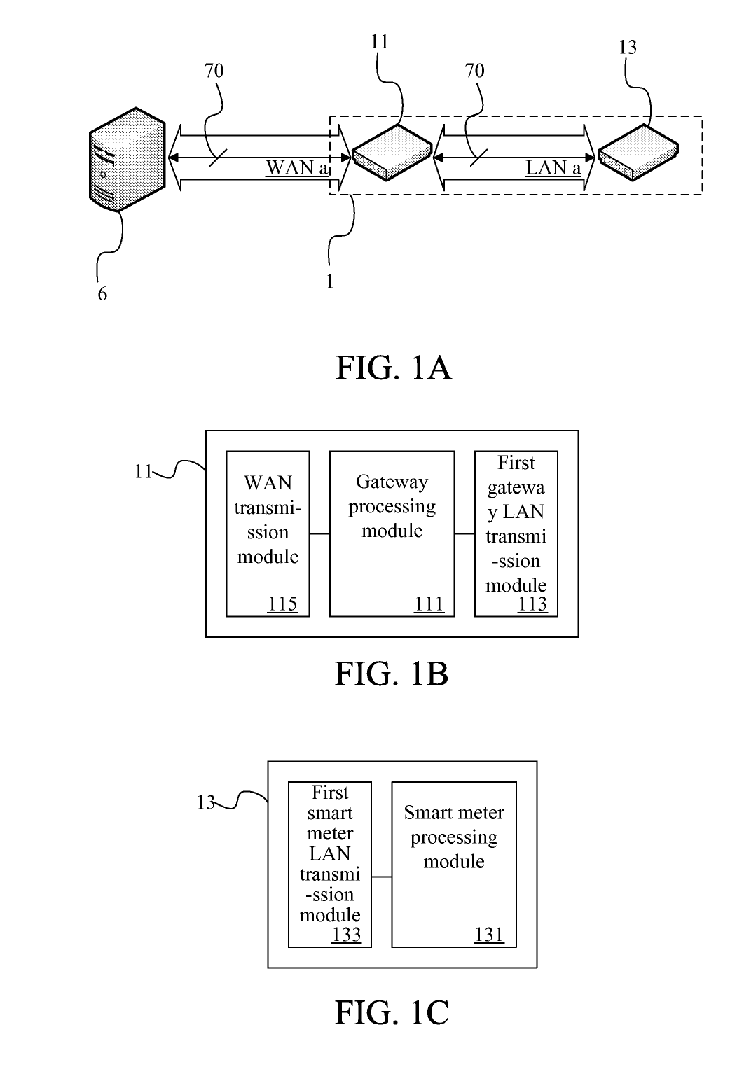

Please refer to FIG. 1A to FIG. 1C together. FIG. 1A is a schematic view of an AMI site survey system 1 according to a first embodiment of the present invention. The AMI site survey system 1 comprises a gateway simulation equipment 11 and a smart meter simulation equipment 13. FIG. 1B is a block diagram of the gateway simulation equipment 11 according to the first embodiment of the present invention. The gateway simulation equipment 11 comprises a gateway processing module 111, a first gateway LAN transmission module 113 and a WAN transmission module 115. FIG. 1C is a block diagram of the smart meter simulation equipment 13 according to the first embodiment of the present invention. The smart meter simulation equipment 13 comprises a information simulation processing module 131 and a first smart meter LAN transmission module 133. Interactions between the individual elements will be further described hereinafter.

First of all, the connection architecture is mainly as follows: a WAN transmission module 135 of the gateway simulation equipment 11 communicates with a server 6 via a WAN communication protocol WAN a, and the first smart meter LAN transmission module 133 of the smart meter simulation equipment 13 communicates with the first gateway LAN transmission module 113 of the gateway simulation equipment 11 via a first LAN communication protocol LAN a.

Based on the aforesaid connection architecture, the information simulation processing module 131 of the smart meter simulation equipment 13 can generate and send a piece of power simulation information 70. Then, the information simulation processing module 131 further controls the first smart meter LAN transmission module 133 to transmit the power simulation information 70 to the first gateway LAN transmission module 113 of the gateway simulation equipment 11 based on the first LAN communication protocol LAN a.

Next, the gateway processing module 111 of the gateway simulation equipment 11 can control the WAN transmission module 115 to transmit the power simulation information 70 to the server 6 based on the WAN communication protocol WAN a. In this way, the server 6 can record a network transmission status of the transmission of the power simulation information 70 via the first LAN communication protocol LAN a and the WAN communication protocol WAN a. Because the power simulation information 70 is used to test the overall transmission via the gateway simulation equipment 11 and the smart meter simulation equipment 13 of the AMI site survey system 1, the reliability of the network transmission status recorded by the server 6 will be substantially improved, and the server 6 can accordingly determine whether this communication path conforms to the predetermined communication quality.

It shall be particularly appreciated that, based on the technology of the first embodiment, the gateway processing module 111 can control the first gateway LAN transmission module 113 and the WAN transmission module 115 to transmit the power simulation information 70 according to a smart meter transmission schedule (not shown) if the gateway simulation equipment 11 connects with multiple smart meter simulation equipments 13 simultaneously in other implementations; on the other hand, the information simulation processing module 131 of each smart meter simulation equipment 13 controls the respective first smart meter LAN transmission module 133 to transmit the power simulation information 70 according to the same smart meter transmission schedule. Thus, the network connection status between each smart meter equipment 13 and backhaul network 6 through the gateway simulation equipment 11 can be sequentially determined.

Furthermore, the packets used by the WAN communication protocol WAN a and the first LAN communication protocol LAN a may have different formats. Therefore, in the first embodiment, the gateway processing module 111 can firstly adjust the power simulation information 70 received from the smart meter simulation equipment 13 from a packet format which conforms to the first LAN communication protocol LAN a into a packet format which conforms to the WAN communication protocol WAN a, and then transmit the adjusted power simulation information 70 to the backhaul network 6.

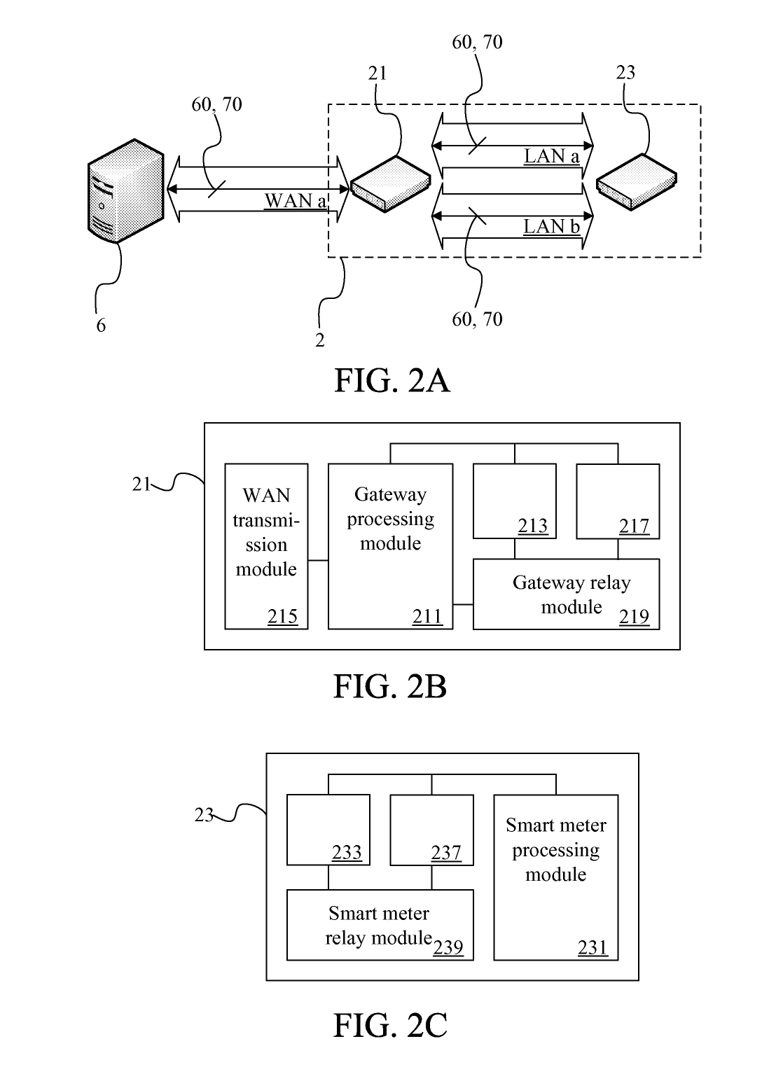

Please refer to FIG. 2A to FIG. 2C together. FIG. 2A is a schematic view of an AMI site survey system 2 according to a second embodiment of the present invention. The AMI site survey system 2 comprises a gateway simulation equipment 21 and a smart meter simulation equipment 23. FIG. 2B is a block diagram of the gateway simulation equipment 21 according to the second embodiment of the present invention. The gateway simulation equipment 21 comprises a gateway processing module 211, a first gateway LAN transmission module 213, a WAN transmission module 215, a second gateway LAN transmission module 217, and a gateway relay module 219. FIG. 2C is a block diagram of the smart meter simulation equipment 23 according to the second embodiment of the present invention. The smart meter simulation equipment 23 comprises a information simulation processing module 231, a first smart meter LAN transmission module 233, a second smart meter LAN transmission module 237 and a smart meter relay module 239. Interactions between the individual elements will be further described hereinafter.

First of all, the connection architecture is mainly as follows: similarly, a WAN transmission module 235 of the gateway simulation equipment 21 communicates with a server 6 via a WAN communication protocol WAN a; the first smart meter LAN transmission module 233 of the smart meter simulation equipment 23 communicates with the first gateway LAN transmission module 213 of the gateway simulation equipment 21 via a first LAN communication protocol LAN a; and the second smart meter LAN transmission module 237 of the smart meter simulation equipment 23 communicates with the second gateway LAN transmission module 217 of the gateway simulation equipment 21 via a second LAN communication protocol LAN b.

Based on the aforesaid connection architecture, the information simulation processing module 231 of the smart meter simulation equipment 23 can generate and send a piece of power simulation information 70. Then, the information simulation processing module 231 can further control the first smart meter LAN transmission module 233 to transmit the power simulation information 70 to the first gateway LAN transmission module 213 of the gateway simulation equipment 21 based on the first LAN communication protocol LAN a.

Next, the gateway processing module 211 of the gateway simulation equipment 21 can control the WAN transmission module 215 to transmit the power simulation information 70 to the server 6 based on the WAN communication protocol WAN a. In this way, the server 6 can record a network transmission status of the transmission of the power simulation information 70 via the first LAN communication protocol LAN a and the WAN communication protocol WAN a.

On the other hand, the information simulation processing module 231 can also control the second smart meter LAN transmission module 237 to transmit the power simulation information 70 to the second gateway LAN transmission module 217 of the gateway simulation equipment 21 based on the second LAN communication protocol LAN b. Thereafter, the gateway processing module 211 of the gateway simulation equipment 21 can control the WAN transmission module 215 to transmit the power simulation information 70 to the server 6 based on the WAN communication protocol WAN a. Thereby, the server 6 can record a network transmission status of the transmission of the power simulation information 70 via the second LAN communication protocol LAN b and the WAN communication protocol WAN a.

It shall be particularly emphasized that, in the second embodiment, the gateway simulation equipment 21 can communicate with the smart meter simulation equipment 23 via the first LAN communication protocol LAN a and the second LAN communication protocol LAN b simultaneously provided that the first LAN communication protocol LAN a and the second LAN communication protocol LAN b do not interfere with each other. However, if the first LAN communication protocol LAN a and the second communication network protocol LAN b interfere with each other, this can also be solved through scheduling.

In detail, the gateway processing module 211 may firstly adjust the gateway relay module 219 according to an LAN transmission schedule (not shown) so that the second gateway LAN transmission module 217 is activated to control the second gateway LAN transmission module 217 to transmit the power simulation information 70. Meanwhile, the information simulation processing module 231 adjusts the smart meter relay module 239 according to the same transmission schedule so that the second smart meter LAN transmission module 237 is activated to control the second smart meter LAN transmission module 237 to transmit the power simulation information 70.

Further speaking, the LAN transmission schedule is mainly used for scheduling the turn-on and turn-off of the first network transmission module (the first gateway LAN transmission module 213 and the first smart meter LAN transmission module 233) and the second network transmission module (the second gateway LAN transmission module 217 and the second smart meter LAN transmission module 237) via the relay module. In this way, the transmission order of the first LAN communication protocol LAN a and the second LAN communication protocol LAN b can be scheduled so that interferences caused by simultaneous transmission of the two LAN communication protocols can be avoided.

Furthermore, in the second embodiment, the desirable communication protocol may also be decided through use of command of the server 6 to increase the flexibility in use. Specifically, the gateway processing module 211 and the information simulation processing module 231 can receive a control command 60 from the server 6. Then, the information simulation processing module 231 can control the second smart meter LAN transmission module 237 to transmit the power simulation information 70 to the second gateway LAN transmission module 217 based on the second LAN communication protocol LAN b in response to the control command 60. On the other hand, the gateway processing module 211 also controls the second gateway LAN transmission module 217 to receive the power simulation information 70 from the second smart meter LAN transmission module 237 based on the second LAN communication protocol LAN b in response to the control command 60.

Therefore, through use of the aforesaid schedule and control command, the server 6 can record the following two network transmission statuses of the transmission of the power simulation information 70 simultaneously: (1) the network transmission status via the first LAN communication protocol LAN a and the WAN communication protocol WAN a; and (2) the network transmission status via the second LAN communication protocol LAN b and the WAN communication protocol WAN a. Thus, the server 6 can determine which transmission path is of a better quality directly.

Additionally, the gateway simulation equipment 21 of the present invention can further send a control command to the smart meter simulation equipment 23 directly, and record the network transmission status of the transmission of the power simulation information via the first LAN communication protocol LAN a or the second LAN communication protocol LAN b when the smart meter simulation equipment 23 transmits the power simulation information back. In this way, the gateway simulation equipment 21 of the present invention can further record the transmission status of the LANs (the first LAN communication protocol LAN a and the second LAN communication protocol LAN b) separately for subsequent use by the user.

It shall be particularly appreciated that, the WAN communication protocols described in the aforesaid embodiments may each be one of the broadband power line communication protocol, the narrowband power line communication protocol, the 3rd generation network communication protocol, the WiMAX network communication protocol, and the LTE communication protocol. When the WAN communication protocol is connected to a high-voltage equipment node via the broadband power line, it can be further transmitted to the backhaul network from the high-voltage equipment node via an optical fiber. The LAN communication protocols may each be one of the broadband power line communication protocol, the narrowband power line communication protocol, and the ZigBee communication protocol. However, this is not intended to limit the implementations of the present invention.

According to the above descriptions, the AMI site survey system of the present invention evaluates the overall network transmission of the smart meter, the gateway and the server in a more automatic way, thereby reducing the labor cost substantially and increasing the evaluation accuracy.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An advanced metering infrastructure (AMI) site survey system, comprising:
a gateway simulation equipment, including:
a gateway processing module;
a wide area network (WAN) transmission module, communicating with a server via a WAN communication protocol; and
a first gateway local area network (LAN) transmission module;
a smart meter simulation equipment, including:
an information simulation processing module, being configured to send a piece of power simulation information;
a first smart meter LAN transmission module, communicating with the first gateway LAN transmission module via a first LAN communication protocol;
wherein the information simulation processing module is further configured to control the first smart meter LAN transmission module to transmit the power simulation information to the first gateway LAN transmission module based on the first LAN communication protocol;
wherein the gateway processing module is configured to control the WAN transmission module to transmit the power simulation information to the server based on the WAN communication protocol so that the server records a network transmission status of the transmission of the power simulation information via the first LAN communication protocol and the WAN communication protocol.

2. The AMI site survey system as claimed in claim 1, wherein the gateway simulation equipment further comprises a second gateway LAN transmission module; the smart meter simulation equipment further comprises a second smart meter LAN transmission module; the second smart meter LAN transmission module communicates with the second gateway LAN transmission module via a second LAN communication protocol; the information simulation processing module is further configured to control the second smart meter LAN transmission module to transmit the power simulation information to the second gateway LAN transmission module based on the second LAN communication protocol; and the gateway processing module is further configured to control the second gateway LAN transmission module to receive the power simulation information from the second smart meter LAN transmission module based on the second LAN communication protocol so that the server records a network transmission status of the transmission of the power simulation information via the second LAN communication protocol and the WAN communication protocol.

3. The AMI site survey system as claimed in claim 2, wherein the gateway simulation equipment further comprises a gateway relay module; the smart meter simulation equipment further comprises a meter relay module; the gateway processing module further adjusts the gateway relay module according to a transmission schedule to control the second gateway LAN transmission module to transmit the power simulation information; and the information simulation processing module also adjusts the meter relay module according to the transmission schedule to control the second smart meter LAN transmission module to transmit the power simulation information.

4. The AMI site survey system as claimed in claim 2, wherein the gateway processing module and the information simulation processing module further receive a control command from the server; the information simulation processing module is further configured to control the second smart meter LAN transmission module to transmit the power simulation information to the second gateway LAN transmission module based on the second LAN communication protocol in response to the control command; and the gateway processing module is further configured to control the second gateway LAN transmission module to receive the power simulation information from the second smart meter LAN transmission module based on the second LAN communication protocol in response to the control command.

5. The AMI site survey system as claimed in claim 1, wherein the gateway processing module further controls the first gateway LAN transmission module and the WAN transmission module to transmit the power simulation information according to a transmission schedule; and the information simulation processing module also controls the first smart meter LAN transmission module to transmit the power simulation information according to the smart meter transmission schedule.

6. The AMI site survey system as claimed in claim 1, wherein the gateway processing module is further configured to adjust the format of the power simulation information and control the WAN transmission module to transmit the power simulation information to the server based on the WAN communication protocol.

7. The AMI site survey system as claimed in claim 1, wherein the WAN communication protocol is one of the broadband power line communication protocol, narrowband power line communication protocol, the 3rd generation network communication protocol, the WiMAX network communication protocol, and the LTE communication protocol.

8. The AMI site survey system as claimed in claim 1, wherein the first LAN communication protocol is one of the broadband power line communication protocol, the narrowband power line communication protocol, and the ZigBee communication protocol.

9. A gateway simulation equipment for an AMI site survey system, the AMI site survey system further comprising a smart meter simulation equipment for sending a piece of power simulation information, the gateway simulation equipment comprising:
a gateway processing module;
a WAN transmission module, communicating with a server via a WAN communication protocol; and
a first gateway LAN transmission module, communicating with the smart meter simulation equipment via a first LAN communication protocol, and receiving the power simulation information from the smart meter simulation equipment based on the first LAN communication protocol;
wherein the gateway processing module is configured to control the WAN transmission module to transmit the power simulation information to the server based on the WAN communication protocol so that the server records a network transmission status of the transmission of the power simulation information via the first LAN communication protocol and the WAN communication protocol.

10. The gateway simulation equipment as claimed in claim 9, further comprising a second gateway LAN transmission module for communicating with the smart meter simulation equipment via a second LAN communication protocol, the gateway processing module being further configured to control the second gateway LAN transmission module to receive the power simulation information from the smart meter simulation equipment based on the second LAN communication protocol so that the server records a network transmission status of the transmission of the power simulation information via the second LAN communication protocol and the WAN communication protocol.

11. The gateway simulation equipment as claimed in claim 10, further comprising:
a gateway relay module;
wherein the gateway processing module further adjusts the gateway relay module according to a transmission schedule so as to control the second gateway LAN transmission module to transmit the power simulation information.

12. The gateway simulation equipment as claimed in claim 10, wherein the gateway processing module further receives a control command from the server and controls the second gateway LAN transmission module to receive the power simulation information from the second smart meter LAN transmission module based on the second LAN communication protocol in response to the control command.

13. The gateway simulation equipment as claimed in claim 9, wherein the gateway processing module further controls the first gateway LAN transmission module and the WAN transmission module to transmit the power simulation information according to a transmission schedule.

14. The gateway simulation equipment as claimed in claim 9, wherein the gateway processing module is further configured to adjust the format of the power simulation information and control the WAN transmission module to transmit the power simulation information to the server based on the WAN communication protocol.

15. The gateway simulation equipment as claimed in claim 9, wherein the WAN communication protocol is one of the broadband power line communication protocol, the narrowband power line communication protocol, the 3rd generation network communication protocol, the WiMAX network communication protocol, and the LTE communication protocol.

16. The gateway simulation equipment as claimed in claim 9, wherein the first LAN communication protocol is one of the broadband power line communication protocol, the narrowband power line communication protocol, and the ZigBee communication protocol.

17. A smart meter simulation equipment for an AMI site survey system, the AMI site survey system further comprising a gateway simulation equipment communicating with a server via a WAN communication protocol, the smart meter simulation equipment comprising:
a first smart meter LAN transmission module, communicating with the gateway simulation equipment via a first LAN communication protocol;
an information simulation processing module, being configured to send a piece of power simulation information, and control the first smart meter LAN transmission module to transmit the power simulation information to the gateway simulation equipment based on the first LAN communication protocol so that the gateway simulation equipment transmits the power simulation information to the server based on the WAN communication protocol and the server records a network transmission status of the transmission of the power simulation information via the first LAN communication protocol and the WAN communication protocol.

18. The smart meter simulation equipment as claimed in claim 17, further comprising a second smart meter LAN transmission module, the second smart meter LAN transmission module communicating with the gateway simulation equipment via a second LAN communication protocol, and the information simulation processing module being further configured to control the second smart meter LAN transmission module to transmit the power simulation information to the second gateway LAN transmission module based on the second LAN communication protocol so that the server records a network transmission status of the transmission of the power simulation information via the second LAN communication protocol and the WAN communication protocol.

19. The smart meter simulation equipment as claimed in claim 18, further comprising:
a meter relay module;
wherein the information simulation processing module further adjusts the meter relay module according to a transmission schedule so as to control the second smart meter LAN transmission module to transmit the power simulation information.

20. The smart meter simulation equipment as claimed in claim 18, wherein the information simulation processing module further receives a control command from the server, and the information simulation processing module is further configured to control the second smart meter LAN transmission module to transmit the power simulation information to the second gateway LAN transmission module based on the second LAN communication protocol in response to the control command.

21. The smart meter simulation equipment as claimed in claim 17, wherein the information simulation processing module further controls the first smart meter LAN transmission module to transmit the power simulation information according to a transmission schedule.

22. The smart meter simulation equipment as claimed in claim 17, wherein the first LAN communication protocol is one of the broadband power line communication protocol, the narrowband power line communication protocol, and the ZigBee communication protocol.
